(19) United States
(12) Patent Application Publication
(10) Pub. No.: US 2025/0291587 A1
(43) Pub. Date: Sep. 18, 2025

(54) SOFTWARE DEVELOPMENT IDE

(71) Applicant: Apple Inc., Cupertino, CA (US)

(72) Inventors: Hamza B. Sohail, Santa Clara, CA (US); Anthony R. Newnam, San Francisco, CA (US); Christopher R. D'Angelo, Santa Clara, CA (US); Han Ming Ong, Los Altos, CA (US); Joel Middendorf, Sunnyvale, CA (US); Phillip J. Azar, Oakland, CA (US)

(21) Appl. No.: 18/960,698

(22) Filed: Nov. 26, 2024

Related U.S. Application Data
(60) Provisional application No. 63/565,177, filed on Mar. 14, 2024.

(51) Int. Cl. G06F 8/76

(52) U.S. Cl. CPC G06F 8/76

(57) ABSTRACT

Methods, systems, and apparatus, including computer programs encoded on computer storage media, for presenting data for potential performance issues in a software development IDE. One of the methods includes maintaining a development call stack captured as a result of identification of a potential development performance issue while an application was executed on a physical developer device or simulated device; maintaining an end-user application call stack captured as a result of identification of a potential end-user application performance issue; determining whether a potential end-user application performance issue matches a potential development performance issue; and providing instructions to cause presentation of a user interface on a display that depicts at least a portion of human readable code for the application and a user interface element that identifies a potential performance issue for which the potential end-user application performance issue matches the potential development performance issue.

### CROSS-REFERENCE TO RELATED APPLICATION

This application claims the benefit of U.S. Provisional Application No. 63/565,177, filed on Mar. 14, 2024, the contents of which are incorporated by reference herein.

### BACKGROUND

Software applications can execute on devices used in a variety of contexts. For instance, a particular software application can execute in multiple different countries, with different interfaces for different languages. In some examples, the particular software application can execute on different hardware, different operating systems, e.g., as newer versions of operating systems are released, or a combination of both.

### SUMMARY

In general, one aspect of the subject matter described in this specification can be embodied in methods that include the actions of maintaining, for each of a plurality of potential development performance issues for an application, a development call stack captured as a result of identification of the potential development performance issue while the application was executed on a physical developer device or simulated device; maintaining, for each of a plurality of potential end-user application performance issues for the application, an end-user application call stack captured as a result of identification of the potential end-user application performance issue while the application was executed on an end-user device; determining, for each of at least some potential end-user application performance issues from the plurality of potential end-user application performance issues and using the corresponding call stacks, whether the potential end-user application performance issue matches a potential development performance issue from the plurality of potential development performance issues; and providing instructions to cause presentation of a user interface on a display that depicts at least a portion of human readable code for the application and a user interface element that identifies a potential performance issue for which the potential end-user application performance issue matches the potential development performance issue.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. The method can include determining, for at least one of the potential development performance issues, that there is not a matching potential end-user application performance issue; and in response to determining, for the at least one of the potential development performance issues, that there is not a matching potential end-user application performance issue, determining to skip presentation of information about the at least one of the potential development performance issues in the user interface.

In some implementations, each of the call stacks can include one or more operating system frames and one or more application frames, at least one of the one or more application frames being specific to the application. Determining, for each of at least some potential end-user application performance issues from the plurality of potential end-user application performance issues and using the corresponding call stacks, whether the potential end-user application performance issue matches a potential development performance issue from the plurality of potential development performance issues can include determining, in the development call stack, one or more development application frames; determining, in the end-user application call stack, one or more end-user application frames; and determining whether a last development frame in the one or more development application frames matches a last end-user application frame in the one or more end-user application frames.

In some implementations, determining whether the last development frame in the one or more development application frames matches the last end-user application frame in the one or more end-user application frames can include determining whether a last development region that includes the last development frame in the one or more development application frames matches a last end-user application region that includes the last end-user application frame in the one or more end-user application frames.

In some implementations, the method can include determining a type of the potential end-user application performance issue; selecting a matching algorithm using the type of the potential end-user application performance issue; and selecting, from the plurality of potential development performance issues using the type of the potential end-user application performance issue, the potential development performance issue that has the type of the potential end-user application performance issue. Determining whether the potential end-user application performance issue matches the potential development performance issue from the plurality of potential development performance issues can use the matching algorithm for the type of the potential end-user application performance issue.

In some implementations, providing the instructions to cause presentation of the user interface can include providing the instructions to cause presentation of the user interface that depicts at least a portion of human readable code for the application and a user interface element that identifies i) a code section of the portion of human readable code that likely causes the potential performance issue for which the potential end-user application performance issue matches the potential development performance issue and ii) indicates that there are reports of potential end-user application issues with the code section.

In some implementations, providing the instructions to cause presentation of the user interface can be responsive to receiving a request for presentation of a library of the application that includes the portion of human readable code.

In some implementations, providing the instructions to cause presentation of the user interface can include providing the instructions to cause presentation of the user interface that depicts at least the portion of human readable code for the application and, for only the potential performance issues for which the potential end-user application performance issue matches the potential development performance issue, a user interface element that identifies the potential performance issue.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, by presenting only a subset of potential development performance issues in the software IDE, the systems and methods described in this specification can reduce computational resource usage that would otherwise be required to present information for all potential development performance issues. In some implementations, by presenting only a subset of potential development performance issues in the software IDE, the systems and methods described in this specification can improve a user interface experience that might otherwise be overwhelming upon presentation of too many potential performance issues. In some implementations, by presenting only a subset of potential development performance issues in the software IDE, the systems and methods described in this specification can surface potential software issues that likely have a larger impact than other issues on a software application, e.g., the issues that would have the most measurable customer impact in terms of improving performance when the issues are fixed.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example of an environment in which a developer device communicates with a development system.

FIG. 2 is a flow diagram of an example process for causing presentation of a software IDE with user interface elements for potential performance issues.

FIG. 3 depicts an example stack matching process.

FIG. 4 depicts an example user interface for a software IDE.

FIG. 5 is a block diagram of a computing system that can be used in connection with computer-implemented methods described in this specification.

Like reference numbers and designations in the various drawings indicate like elements.

### DETAILED DESCRIPTION

Software applications can have various performance issues. These issues can include a user interface hanging, a slow application launch, or excessive disk write access, to name a few examples. The excessive disk write access can reduce a storage lifetime given a limited number of reads, writes, or both.

An application integrated development environment (“IDE”) can enable a developer to update their code. Sometimes the IDE can maintain data about potential performance issues that are detected on the developer's device. For instance, the IDE can receive data about potential performance issues from one or more application programming interface (“API”) calls triggered on the developer device.

To reduce a quantity of potential performance issues identified by API calls that the IDE manages, about which the IDE presents information in a user interface, or both, the IDE can access end-user application data received from multiple devices that execute a production version of the application. This can enable the IDE to present information about performance issues that affect the production version of the application, and devices executing that production version, rather than all potential performance issues, improving a developer experience using the IDE, reducing computational resource usage of the IDE managing data for the potential performance issues, or both.

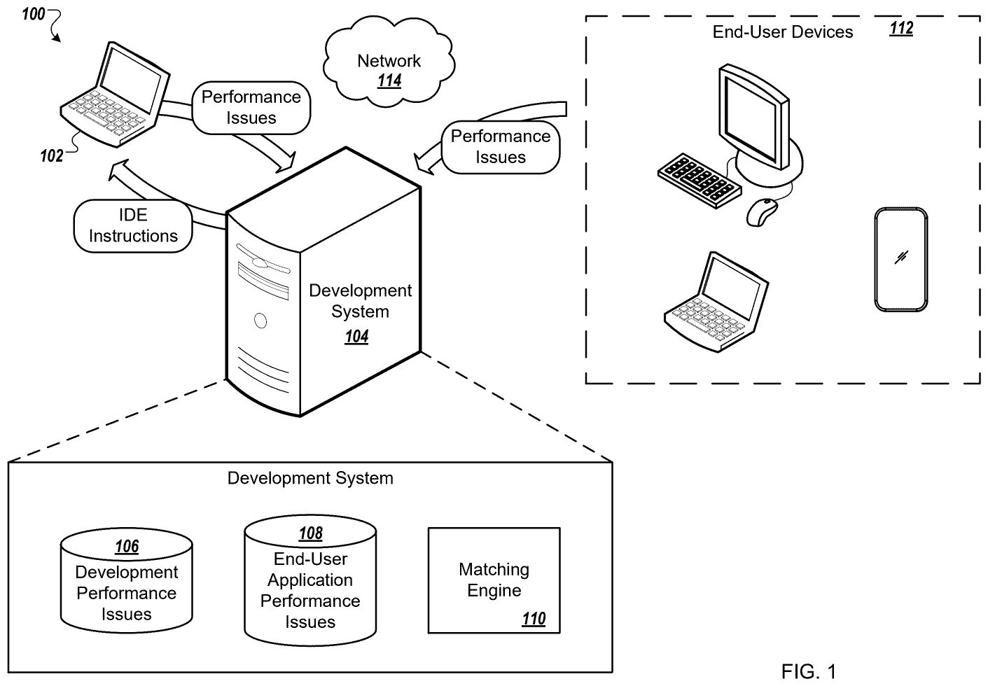

FIG. 1 depicts an example of an environment 100 in which a developer device 102 communicates with a development system 104. The developer device 102 can receive, from the development system 104, instructions for presentation of a software development integrated development environment (“IDE”). The software development IDE can present information about human readable software code for an application developed, at least in part, on the developer device 102.

During development, the developer device 102 can execute the application. As part of the application execution, the developer device 102 can provide data about potential development performance issues to the development system 104. The data can include a call stack generated during execution of the application. The call stack can be a backtrace, or a sample of a call stack, from a thread, e.g., a single thread. A collection of frames in a call tree can form a signature that can uniquely identify a portion of code executed on a device, whether the code is operating system code or code for another application, e.g., a third party application.

The developer device 102 can generate, during execution of the application, a log. A log can contain call stacks for the application. Over time as the application is executed multiple times on the developer device 102, the developer device 102 can maintain multiple logs with call stacks that map to a signature. The signature can be for a potential developer performance issue.

The developer device 102 can provide data for the potential development performance issues to the development system 104. For instance, the developer device 102 can provide the data, e.g., a call stack or a signature, to the development system 104 upon detection of the potential performance issue, upon detection of a threshold occurrences of the potential performance issue, or a combination of both. In some examples, the developer device 102 can provide a log for an execution of the application, e.g., for each execution of the application, to the development system 104. The log can include the data for the potential performance issue.

In some implementations, the development system 104 can generate a signature for the potential development performance issue, or any other appropriate type of issue. For instance, the development system 104 can receive a call stack from the developer device 102 and then generate a corresponding signature for the call stack.

The development system 104 can maintain the data for the potential developer performance issues in a development performance issue data 106. In some examples, the data 106, a potential end-user application performance issues data 108, or both, can be a tree structure representation of received logs. Nodes in the tree structure can represent frames from the call stacks. A matching engine 110 that detects call stacks that occur in both data sets 106-108 can use a chained hash table to look up nodes in the tree. The data can be any appropriate type of data structure, such as a database, an in-memory data structure, or a combination of both.

Once the application is published, e.g., through an application store or otherwise available for installation on an end-user device 112, the development system 104 can receive data for potential end-user application performance issues from at least some of the end-user devices 112 that execute the application. For instance, the development system 104 can receive logs, call stacks, or a combination of both, for potential runtime performance issues detected during execution of the application on a device from the end-user devices 112.

The development system 104 can receive the data for the potential end-user application performance issues using any appropriate process. For example, the end-user devices 112 can include code that detects potential performance issues and transmits corresponding data, e.g., anonymized data, to the development system 104. The development system 104, e.g., a plugin or another component for the software development IDE executing on the development system 104, can receive the data from the end-user devices 112.

The development system 104 can determine whether any of the potential end-user application performance issues matches a potential development performance issue, as discussed in more detail below. This can occur at any appropriate time. For instance, the development system 104 can make this determination upon receipt of a request to present a software IDE, upon a request to present a particular source code file in the software IDE, or a combination of both.

Upon receipt of a request to present the software IDE, the development system 104 can provide instructions to the developer device 102 to cause presentation of the software IDE on a display for the developer device 102. The display can be any appropriate display, e.g., integrated into or otherwise connected to the developer device 102. The software IDE includes information about potential end-user application performance issues that match potential development performance issues. By presenting only a subset of potential development performance issues in the software IDE, the developer device 102 can reduce computational resource usage that would otherwise be required to present information for all potential development performance issues. In some examples, by presenting only a subset of potential development performance issues in the software IDE, the developer device 102 can improve a user interface experience that might otherwise be overwhelming upon presentation of too many potential performance issues.

In some implementations, the development system 104 can determine whether a log is symbolicated. If so, the development system 104 can store data for the log in the corresponding data 106-108. If not, the development system 104 can determine to skip storage of the log in the corresponding data 106-108, e.g., can determine to discard data for the log without storing the data in a data 106-108.

In some implementations, the developer device 102 and the development system 104 can be part of the same system or device. For instance, the developer device 102 can maintain the data 106-108. The developer device 102 can have, as part of the software IDE, the matching engine 110. For example, the matching engine 110 can be part of a plugin for the software IDE. In these implementations, the data for the potential end-user application performance issues can be anonymized.

The development system 104 can receive logs from the end-user devices 112. The development system 104 can store the logs in a data structure in memory. Upon execution of the software IDE, access to a corresponding source code file, or both, the development system 104 can populate the potential end-user application performance issues data 108 with data from the logs. In some examples, this data 108 population can occur when the plugin is initialized.

The development system 104 is an example of a system implemented as computer programs on one or more computers in one or more locations, in which the systems, components, and techniques described in this specification are implemented. The developer device 102 and the end-user devices 112 can include personal computers, mobile communication devices, and other devices that can send and receive data over a network 114. The network 114, such as a local area network (“LAN”), wide area network (“WAN”), the Internet, or a combination thereof, connects the developer device 102, the development system 104, the end-user devices 112. The development system 104 can use a single computer or multiple computers operating in conjunction with one another, including, for example, a set of remote computers deployed as a cloud computing service.

The development system 104 can include several different functional components, including the matching engine 110. The matching engine 110 can include one or more data processing apparatuses, can be implemented in code, or a combination of both.

The various functional components of the development system 104 can be installed on one or more computers as separate functional components or as different modules of a same functional component. For example, the matching engine 110 can be implemented as computer programs installed on one or more computers in one or more locations that are coupled to each through a network. In cloud-based systems for example, these components can be implemented by individual computing nodes of a distributed computing system.

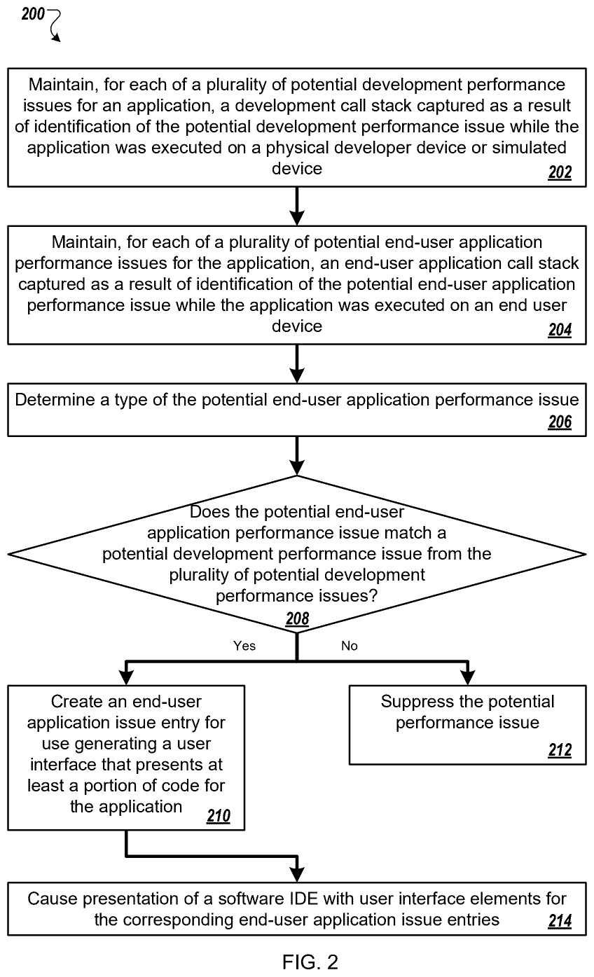

FIG. 2 is a flow diagram of an example process 200 for causing presentation of a software IDE with user interface elements for potential performance issues. For example, the process 200 can be used by the development system 104 or the developer device 102 from the environment 100.

The development system maintains, for each of a plurality of potential development performance issues for an application, a development call stack captured as a result of identification of the potential development performance issue while the application was executed on a physical developer device or simulated device (202). For instance, the developer device can generate data for one or more end-user application issues which data includes a call stack. In some examples, the data can be for a simulated execution of the application. The development system or the developer device can perform the simulated execution.

The development system maintains, for each of a plurality of potential end-user application performance issues for the application, an end-user application call stack captured as a result of identification of the potential end-user application performance issue while the application was executed on an end-user device (204). For example, the development system can receive data for a potential end-user application issue from a end-user, e.g., runtime, device. The development system, e.g., a plugin for the software development IDE, can receive the data from a dylib on the corresponding end-user device.

The development system can determine a type of the potential end-user application performance issue (206). For instance, the development system, e.g., the plugin, can determine whether the potential performance issue is a potential hang issue, a potential disk write issue, or a potential launch issue.

In implementations in which the development system uses an issue type, the development system can maintain different data sets for different issues. For example, the development system can maintain a first data set for potential hang issues, a second data set for potential write issues, and a third data set for potential launch issues. The multiple data sets can include development data sets, end-user application data sets, or a combination of both.

The development system determines whether the potential end-user application performance issue matches a potential development performance issue from the plurality of potential development performance issues (208). For instance, the development system can determine whether the call stack for the potential end-user application performance issue matches a call stack for a potential development performance issue given the maintained data for the plurality of potential development performance issues, e.g., the potential development performance issue data or data sets. When using an issue type, the development system can access the data set that maintains development data for the corresponding issue type.

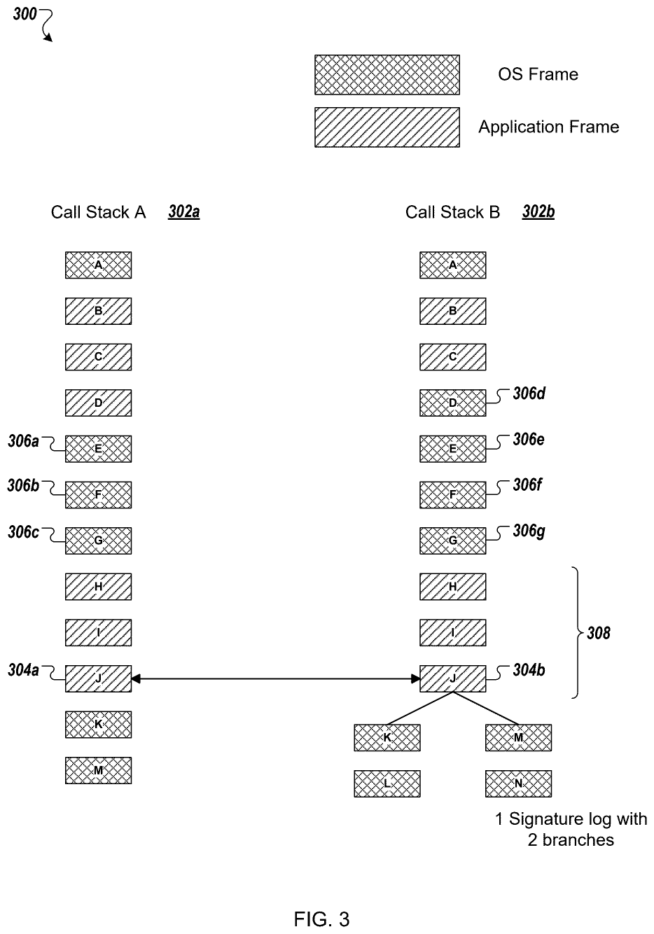

FIG. 3 depicts an example stack matching process 300. In the process 300, a matching engine compares two call stacks A-B 302a-b to determine whether the call stacks satisfy a similarity threshold. One of the two call stacks A-B 302a-b, e.g., the first call stack A 302a, represents a potential development performance issue. The other of the two call stacks A-B 302a-b, e.g., the second call stack B 302b, represents a potential end-user application performance issue.

In some examples, the similarity threshold requires that the last application frames 304a-b, e.g., third party frames, of the two call stacks A-B 302a-b are exactly the same. In these examples, the matching engine determines the application frames in the call stacks A-B 302a-b. From the application frames in each of the call stacks A-B 302a-b, the matching engine determines the last application frames 304a-b in the call stacks A-B 302a-b. The matching engine determines whether the last application frames 304a-b satisfy the similarity threshold, e.g., are the same. If the last application frames 304a-b satisfy the similarity threshold, the matching engine determines that the potential end-user application performance issue for a corresponding one of the call stacks A-B 302a-b matches the potential development performance issue for the corresponding other of the call stacks A-B 302a-b. If not, the matching engine can determine that the two potential performance issues do not match.

In some implementations, the development system focuses on the last application frames 304a-b since those frames are the most likely cause of any potential performance issues. In some examples, the development system focuses on the last application frames 304a-b since those frames are the frames for which information can be presented in the software development IDE. A developer, e.g., a third party developer who does not change code for the operating system, can then access the software development IDE to make changes to the application's source code given the information presented in the software development IDE.

In some implementations, the development system can maintain data about potential development, end-user application, or both, performance issues in a tree. By using a tree to maintain the potential performance issue data, e.g., call stack data, the development system can more quickly determine whether data in a development performance issue tree satisfies a similarity threshold with data in an end-user application performance issue tree. For the tree structure, the nodes in the tree can each represent a corresponding frame from a call stack, e.g., or a call stack.

A data structure representing a performance issue tree can include data for a collection of trees. The data structure can be backed by a chained hash table that has, as a key, a function name. The development system can use the chained hash table to more quickly lookup data for a new entry, or during a matching operation, compared to other systems. The chained hash table can include pointers to the associated nodes in the tree structure where the corresponding frames, e.g., identified by the key, appear. In some examples, use of a chained hash table can reduce a likelihood that the development system will lookup all trees in the data structure unnecessarily, e.g., when determining whether to create a new entry, during a matching operation, or both. For instance, use of a chained hash table can enable a matching operation with a time complexity of O (1), reduce a number of tree structures analyzed during the matching operation, or both.

In some implementations, the development system can invert a call stack when storing the call stack in memory. This can enable the development system to include the last third party frame toward the beginning of a tree structure, rather than the end, optionally enabling faster lookup. For instance, when the development system accesses the tree, the first frame it detects can be the last third party frame. In these implementations, the development system can determine whether the similarity threshold is satisfied by determining whether the last third party frame in both an end-user application tree and a development tree are within a threshold distance of the beginning of the inverted call stack. The threshold distance can be different for the end-user application tree and the development tree, e.g., there can be two different threshold distances.

When traversing an inverted call stack, the development system can determine whether additional frames in the end-user application tree and the development tree satisfy the similarity threshold, collect other data about trees that satisfy the similarity threshold, or both. For instance, the development system can collect statistics about the trees that can be presented in the software development IDE along with the user interface element that indicates the code related to the potential performance issue.

In some implementations, the similarity threshold requires that one or more trigger frames in both of the call stacks A-B 302a-b match. A trigger frame 306a-g can be a frame generated because of an operating system method that was interposed between calls for the application. For instance, the matching engine can determine whether the trigger frames 306c and 306g, from the call stacks A-B 302a-b respectively, match. When the trigger frames match, the matching engine can determine that the potential end-user application performance issue matches the potential development performance issue. If not, the matching engine can determine that the two potential performance issues do not match.

In some implementations, the similarity threshold requires that all application frames in a last application region 308 match. For instance, the matching engine can determine that both of the call stacks A-B 302a-b include a last application region 308 with frames H, I, and J. The matching engine can compare the frames from the two last application regions 308 to determine whether the frames match. Here, the matching engine would compare corresponding H frames, corresponding I frames, and corresponding J frames. When the frames in the last application regions match, the matching engine can determine that the potential end-user application performance issue matches the potential development performance issue. If not, the matching engine can determine that the two potential performance issues do not match.

In some examples, when matching portions of the call stacks A-B 302a-b other than the last application frame, some frames can have a frame signature removed. This can reduce false mismatches when the matching engine uses a similarity threshold that requires a match of other frames or groups of frames, such as a trigger frame or a last application region. In these examples, when storing data for a call stack, the development system can remove the frame signature, e.g., a frame number or letter as identified by the values A-N in FIG. 3.

Returning to FIG. 2, in some implementations, the development system can select a matching algorithm using the issue type for the potential performance issue, e.g., end-user application performance issue. For instance, the development system can determine whether the issue type is an application hang issue, a disk write issue, or a slow application launch issue. Upon determining that the issue type is an application hang issue or a slow application launch issue, the matching algorithm can use one or more of the processes described above, e.g., for the similarity threshold.

When the issue type is a disk write issue, the similarity threshold can include one or more additional requirements, e.g., in addition to those discussed above. For instance, the similarity threshold can require that if two call stacks match, e.g., as described above which can include matching of only a portion of the call stacks, the potential performance issue has a solution likelihood that satisfied a solution criterion. For instance, to reduce a likelihood of causing presentation of potential disk write issues with a low probability of being solved, too many potential issues, or both, the matching engine can determine whether the solution likelihood for the potential disk write issue satisfies the solution criterion. The solution criterion can require that the potential disk write issue have a corresponding entry in a solutions data set. The solutions data set can include data that identifies potential disk write issues and corresponding optimizations. When a potential disk write issue has a corresponding optimization in the solutions data set, the development system can cause presentation in the software development IDE of a user interface element that identifies the potential disk write issue and data for the corresponding optimization. This can increase a likelihood of the potential disk write issue being solved, reduce an implementation time for a solution, or both.

The development system creates an end-user application issue entry for use generating a user interface that presents at least a portion of code for the application (210). This can occur in response to determining that the potential end-user application performance issue matches the potential development performance issue. For instance, the development system can add information about the potential performance issue to end-user application issue text and determine to surface that end-user application issue text in a user interface.

The development system suppresses the potential performance issue (212). This can occur in response to determining that the potential end-user application performance issue does not match the potential development performance issue. For instance, the development system can determine to skip presentation of information about the potential performance issue in a user interface. This can include determining that the potential performance issue, e.g., the potential development performance issue, is not likely an actual performance issue, e.g., during runtime execution of the end-user application.

In some implementations, when the issue type satisfies an issue type criteria and the potential issue satisfies an issue threshold, e.g., the issue is determined to be important, the development system can determine to create a development issue entry for the potential performance issue instead of suppressing the potential performance issue.

In some implementations, the development system can maintain message type data. These implementations can include implementations in which both the issue type satisfies the issue type criteria and the potential issue satisfies an issue threshold; or any other appropriate implementation. The message type data can indicate whether data about a potential performance issue should be presented in the software development IDE. Some examples of message types can include “elevatable” and “suppressible.” An elevatable message type can indicate that data for the corresponding potential performance issue should be presented in the software development IDE. This message type can be used for any appropriate type of potential performance issue, e.g., whether or not there is a match between a potential development performance issue and a potential end-user application performance issue. A suppressible message type can indicate that data for the corresponding potential performance issue should not be presented in the software development IDE. For instance, the development system can assign a suppressible message type to only potential development performance issues for which there is not a matching potential end-user application performance issue, e.g., or a proper subset of these potential development performance issues.

The development system causes presentation of a software IDE with user interface elements for the corresponding end-user application issue entries (214). For instance, the development system provides instructions to a developer device, or a component within the development system, to cause presentation of the software IDE. The causation of presentation of the software IDE with the user interface elements can be responsive to receipt of a request. The request can be for presentation of the software IDE, presentation of source code for the application in the software IDE, or a combination of both.

In some examples, the request can be a request for presentation of a particular library for the application. As a result, the development system can perform one or more operations of the process 200 for that library, e.g., rather than for the application as a whole. In these examples, the development system can select the potential performance issues that are associated with code in the library and determine to skip analysis of any potential performance issues associated with code from other libraries.

Using the call stacks, the development system can determine a likely portion of code for the application that triggered generation of a corresponding frame in the call stack. A call stack can be associated with a library for which corresponding code triggered generation of at least one frame in the call stack. In some examples, a call stack might be associated with only one corresponding library, e.g., the library for which the last application frame was generated.

The user interface element for the corresponding end-user application issue can be presented with the likely portion of code that caused the potential performance issue. In this way, the development system can increase a likelihood that the potential performance issue will be fixed by associating the user interface element with the likely portion of code.

The order of operations in the process 200 described above is illustrative only, and causing presentation of a software IDE with user interface elements for potential performance issues can be performed in different orders. For example, maintenance of the development and end-user application potential performance issues can occur substantially in parallel. In some examples, the process 200 can determine an issue type for a performance issue before maintaining data, e.g., a call stack, for the performance issue. For instance, the development system can determine an issue type and select a data set in which to store data for the potential performance issue using the issue type.

In some implementations, the process 200 can include additional operations, fewer operations, or some of the operations can be divided into multiple operations. For example, the process 200 need not perform one or both of operations 206 or 212. In some examples, the process 200 need not perform one or both of operations 206 or 210.

In some implementations, when determining whether a potential end-user application performance issue matches a potential development performance issue, the development system can disregard at least some information for a frame when performing the analysis. For instance, some methods identified in a call stack frame can have, e.g., numbered, prefixes change. This can occur as a result of compiler changes rather than code changes. Since these frames can be located anywhere in a call stack, the development system can determine to disregard potentially dynamic name data, e.g., the dynamic prefixes, when determining whether there is a match. This can increase a likelihood that the development system will detect development and end-user application performance issues that match, which can in turn increase a likelihood that potential performance issues are detected, fixed, or both.

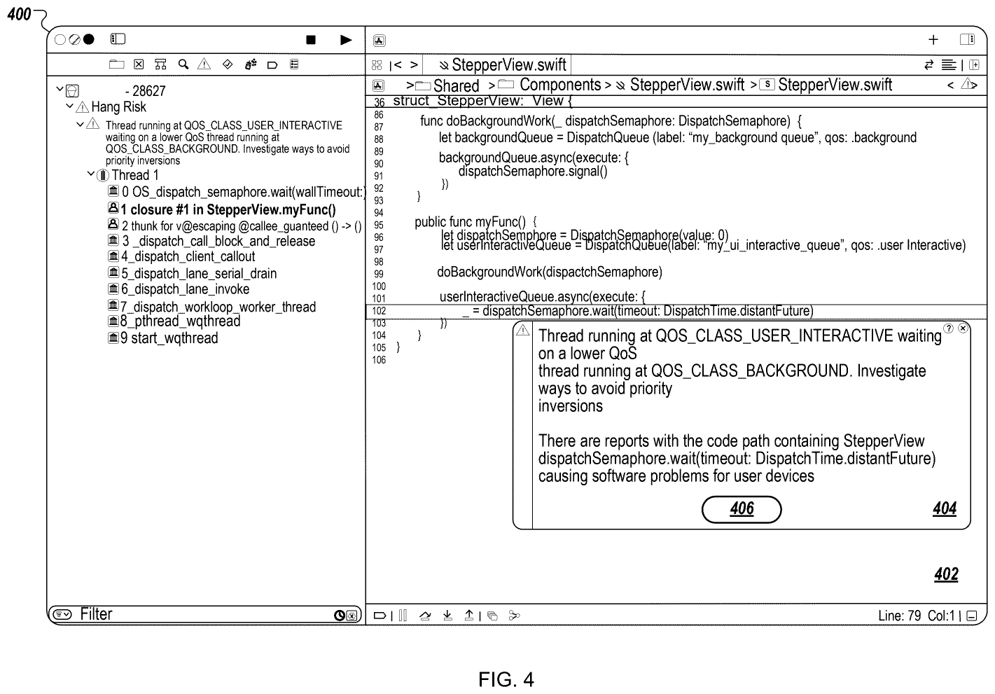

FIG. 4 depicts an example user interface 400 for a software IDE. The user interface 400 includes a display portion 402 that depicts human readable code for a library of an application. The display portion 402 can include a user interface element 404 that indicates that there are reports of potential end-user application issues with the code section. For instance, the user interface element 404 can indicate that both development and end-user application performance issues were identified for the corresponding portion of source code. The user interface element 404 can include information generated from the corresponding call stacks or other appropriate information.

In FIG. 4, the user interface element 404 indicates the particular line of code that likely caused the performance issue. Here, the user interface element 404 indicates that “there are reports with the code path StepperView dispatchSemaphore.wait (timeout: DispatchTime.distantFuture) causing software problems for user devices.” The library for which the human readable source code is presented in the user interface 400 can be the library “StepperView.swift”.

In some implementations, the user interface element 404, e.g., a popup user interface element, can include a selectable user interface element 406, e.g., a link. Upon detecting selection of the selectable user interface element, a corresponding device that is executing the software IDE can present additional information about the performance issue, e.g., the selectable user interface element 406 can trigger presentation of the additional information. For instance, the device can present information about the matched signature for the performance issue, e.g., can present the matched signature or a subset of data from the matched signature. In some examples, the selectable user interface element 406 can be included in another portion of the user interface 400.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” refers broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

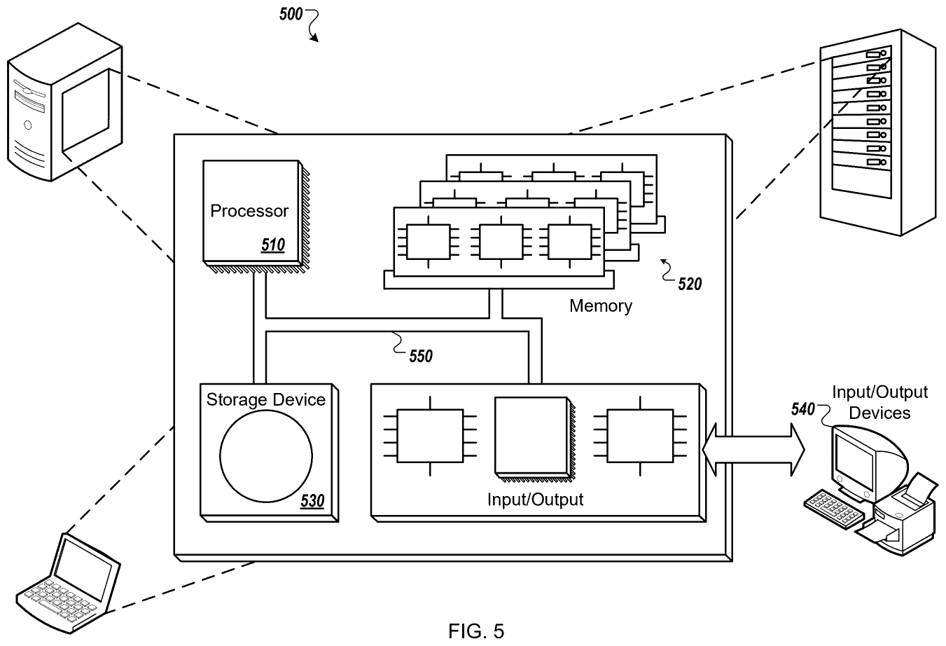

An example of one such type of computer is shown in FIG. 5, which shows a schematic diagram of a computer system 500. The computer system 500 can be used for the operations described in association with any of the computer-implemented methods described previously, according to some implementations. The computer system 500 includes a processor 510, a memory 520, a storage device 530, and an input/output device 540. Each of the components 510, 520, 530, and 540 are interconnected using a system bus 550. The processor 510 is capable of processing instructions for execution within the computer system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the computer system 500. In some implementations, the memory 520 is a computer-readable medium. In some implementations, the memory 520 is a volatile memory unit. In some implementations, the memory 520 is a non-volatile memory unit.

The storage device 530 is capable of providing mass storage for the computer system 500. In some implementations, the storage device 530 is a computer-readable medium. In some implementations, the storage device 530 can be a floppy disk device, a hard disk device, an optical disk device, or a tape device.

The input/output device 540 provides input/output operations for the computer system 500. In some implementations, the input/output device 540 includes a keyboard, a pointing device, a touchscreen, or a combination of these. In some implementations, the input/output device 540 includes a display unit for displaying graphical user interfaces. In some implementations, the input/output device 540 includes a microphone, a speaker, or a combination of both.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
maintaining, for each of a plurality of potential development performance issues for an application, a development call stack captured as a result of identification of the potential development performance issue while the application was executed on a physical developer device or simulated device;
maintaining, for each of a plurality of potential end-user application performance issues for the application, an end-user application call stack captured as a result of identification of the potential end-user application performance issue while the application was executed on an end-user device;
determining, for each of at least some potential end-user application performance issues from the plurality of potential end-user application performance issues and using the corresponding call stacks, whether the potential end-user application performance issue matches a potential development performance issue from the plurality of potential development performance issues; and
providing instructions to cause presentation of a user interface on a display that depicts at least a portion of human readable code for the application and a user interface element that identifies a potential performance issue for which the potential end-user application performance issue matches the potential development performance issue.

2. The method of claim 1, comprising:
determining, for at least one of the potential development performance issues, that there is not a matching potential end-user application performance issue; and
in response to determining, for the at least one of the potential development performance issues, that there is not a matching potential end-user application performance issue, determining to skip presentation of information about the at least one of the potential development performance issues in the user interface.

3. The method of claim 1, wherein:
each of the call stacks comprises one or more operating system frames and one or more application frames, at least one of the one or more application frames being specific to the application; and
determining, for each of at least some potential end-user application performance issues from the plurality of potential end-user application performance issues and using the corresponding call stacks, whether the potential end-user application performance issue matches a potential development performance issue from the plurality of potential development performance issues comprises:
determining, in the development call stack, one or more development application frames;
determining, in the end-user application call stack, one or more end-user application frames; and
determining whether a last development frame in the one or more development application frames matches a last end-user application frame in the one or more end-user application frames.

4. The method of claim 3, wherein determining whether the last development frame in the one or more development application frames matches the last end-user application frame in the one or more end-user application frames comprises determining whether a last development region that includes the last development frame in the one or more development application frames matches a last end-user application region that includes the last end-user application frame in the one or more end-user application frames.

5. The method of claim 1, comprising:
determining a type of the potential end-user application performance issue;
selecting a matching algorithm using the type of the potential end-user application performance issue; and
selecting, from the plurality of potential development performance issues using the type of the potential end-user application performance issue, the potential development performance issue that has the type of the potential end-user application performance issue, wherein:
determining whether the potential end-user application performance issue matches the potential development performance issue from the plurality of potential development performance issues uses the matching algorithm for the type of the potential end-user application performance issue.

6. The method of claim 1, wherein providing the instructions to cause presentation of the user interface comprises providing the instructions to cause presentation of the user interface that depicts at least a portion of human readable code for the application and a user interface element that identifies i) a code section of the portion of human readable code that likely causes the potential performance issue for which the potential end-user application performance issue matches the potential development performance issue and ii) indicates that there are reports of potential end-user application issues with the code section.

7. The method of claim 1, wherein providing the instructions to cause presentation of the user interface is responsive to receiving a request for presentation of a library of the application that includes the portion of human readable code.

8. The method of claim 1, wherein providing the instructions to cause presentation of the user interface comprises providing the instructions to cause presentation of the user interface that depicts at least the portion of human readable code for the application and, for only the potential performance issues for which the potential end-user application performance issue matches the potential development performance issue, a user interface element that identifies the potential performance issue.

9. A system comprising one or more computers and one or more storage devices on which are stored instructions that are operable, when executed by the one or more computers, to cause the one or more computers to perform operations comprising:
maintaining, for each of a plurality of potential development performance issues for an application, a development call stack captured as a result of identification of the potential development performance issue while the application was executed on a physical developer device or simulated device;
maintaining, for each of a plurality of potential end-user application performance issues for the application, an end-user application call stack captured as a result of identification of the potential end-user application performance issue while the application was executed on an end-user device;
determining, for each of at least some potential end-user application performance issues from the plurality of potential end-user application performance issues and using the corresponding call stacks, whether the potential end-user application performance issue matches a potential development performance issue from the plurality of potential development performance issues; and
providing instructions to cause presentation of a user interface on a display that depicts at least a portion of human readable code for the application and a user interface element that identifies a potential performance issue for which the potential end-user application performance issue matches the potential development performance issue.

10. The system of claim 9, the operations comprising:
determining, for at least one of the potential development performance issues, that there is not a matching potential end-user application performance issue; and
in response to determining, for the at least one of the potential development performance issues, that there is not a matching potential end-user application performance issue, determining to skip presentation of information about the at least one of the potential development performance issues in the user interface.

11. The system of claim 9, wherein:
each of the call stacks comprises one or more operating system frames and one or more application frames, at least one of the one or more application frames being specific to the application; and
determining, for each of at least some potential end-user application performance issues from the plurality of potential end-user application performance issues and using the corresponding call stacks, whether the potential end-user application performance issue matches a potential development performance issue from the plurality of potential development performance issues comprises:
determining, in the development call stack, one or more development application frames;
determining, in the end-user application call stack, one or more end-user application frames; and
determining whether a last development frame in the one or more development application frames matches a last end-user application frame in the one or more end-user application frames.

12. The system of claim 11, wherein determining whether the last development frame in the one or more development application frames matches the last end-user application frame in the one or more end-user application frames comprises determining whether a last development region that includes the last development frame in the one or more development application frames matches a last end-user application region that includes the last end-user application frame in the one or more end-user application frames.

13. The system of claim 9, the operations comprising:
determining a type of the potential end-user application performance issue;
selecting a matching algorithm using the type of the potential end-user application performance issue; and
selecting, from the plurality of potential development performance issues using the type of the potential end-user application performance issue, the potential development performance issue that has the type of the potential end-user application performance issue, wherein:
determining whether the potential end-user application performance issue matches the potential development performance issue from the plurality of potential development performance issues uses the matching algorithm for the type of the potential end-user application performance issue.

14. The system of claim 9, wherein providing the instructions to cause presentation of the user interface comprises providing the instructions to cause presentation of the user interface that depicts at least a portion of human readable code for the application and a user interface element that identifies i) a code section of the portion of human readable code that likely causes the potential performance issue for which the potential end-user application performance issue matches the potential development performance issue and ii) indicates that there are reports of potential end-user application issues with the code section.

15. The system of claim 9, wherein providing the instructions to cause presentation of the user interface is responsive to receiving a request for presentation of a library of the application that includes the portion of human readable code.

16. The system of claim 9, wherein providing the instructions to cause presentation of the user interface comprises providing the instructions to cause presentation of the user interface that depicts at least the portion of human readable code for the application and, for only the potential performance issues for which the potential end-user application performance issue matches the potential development performance issue, a user interface element that identifies the potential performance issue.

17. One or more non-transitory computer storage media encoded with instructions that, when executed by one or more computers, cause the one or more computers to perform operations comprising:
maintaining, for each of a plurality of potential development performance issues for an application, a development call stack captured as a result of identification of the potential development performance issue while the application was executed on a physical developer device or simulated device;
maintaining, for each of a plurality of potential end-user application performance issues for the application, an end-user application call stack captured as a result of identification of the potential end-user application performance issue while the application was executed on an end-user device;
determining, for each of at least some potential end-user application performance issues from the plurality of potential end-user application performance issues and using the corresponding call stacks, whether the potential end-user application performance issue matches a potential development performance issue from the plurality of potential development performance issues; and
providing instructions to cause presentation of a user interface on a display that depicts at least a portion of human readable code for the application and a user interface element that identifies a potential performance issue for which the potential end-user application performance issue matches the potential development performance issue.

18. The computer storage media of claim 17, the operations comprising:
determining, for at least one of the potential development performance issues, that there is not a matching potential end-user application performance issue; and
in response to determining, for the at least one of the potential development performance issues, that there is not a matching potential end-user application performance issue, determining to skip presentation of information about the at least one of the potential development performance issues in the user interface.

19. The computer storage media of claim 17, wherein:
each of the call stacks comprises one or more operating system frames and one or more application frames, at least one of the one or more application frames being specific to the application; and
determining, for each of at least some potential end-user application performance issues from the plurality of potential end-user application performance issues and using the corresponding call stacks, whether the potential end-user application performance issue matches a potential development performance issue from the plurality of potential development performance issues comprises:
determining, in the development call stack, one or more development application frames;
determining, in the end-user application call stack, one or more end-user application frames; and
determining whether a last development frame in the one or more development application frames matches a last end-user application frame in the one or more end-user application frames.

20. The computer storage media of claim 19, wherein determining whether the last development frame in the one or more development application frames matches the last end-user application frame in the one or more end-user application frames comprises determining whether a last development region that includes the last development frame in the one or more development application frames matches a last end-user application region that includes the last end-user application frame in the one or more end-user application frames.
